(19) United States
(12) Patent Application Publication
(10) Pub. No.: US 2004/0014855 A1
(43) Pub. Date: Jan. 22, 2004

(54) Transparent or pigmented powder coatings based on certain carboxyl-containing polyesters with hydroxyalkylamides and use thereof

(75) Inventor: Andreas Wenning, Nottuln (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/615,375

(22) Filed: Jul. 9, 2003

(30) Foreign Application Priority Data
Jul. 20, 2002 (DE) 102 33 010.7

(51) Int. Cl. C08L 67/00

(52) U.S. Cl. 524/210

(57) ABSTRACT

Transparent or pigmented powder coating compositions containing carboxyl-containing polyesters and hydroxyalkylamides, and their use as transparent or pigmented powder coating materials.

### BACKGROUND OF THE INVENTION

1. Field of the Invention

The invention relates to transparent or pigmented powder coating materials based on compositions containing carboxyl-containing polyesters and β-hydroxyalkylamides, and their use as powder coating materials.

2. Discussion of the Background

Powder coating materials based on triglycidyl isocyanurate (TGIC) and acid-functional polyesters produce corrosion-resistant, weather-stable powder coatings. However, EP 0 536 085 describes how preparing TGIC in solid form necessitates expensive processes or a relatively large and thus likewise expensive purification effort. Moreover, TGIC is classified by the European Community as a category II mutagen (“is regarded as causing mutations”) and as of May 31, 1998 has required labeling as “toxic”.

Toxicologically unobjectionable powder coatings that are more reactive may include β-hydroxyalkylamide crosslinkers. In U.S. Pat. No. 4,076,917 and U.S. Pat. No. 4,101,606, β-hydroxyalkylamides are combined with polymers having at least one carboxyl or anhydride function, in particular with polyacrylates, to form powder coating materials. U.S. Pat. No. 4,988,767 describes powder coating materials based on hydroxyalkylamides and acidic acrylate resins.

EP 0 322 834 describes thermosetting powder coating materials that contain β-hydroxyalkylamides and polyesters containing acid groups. These coatings with hydroxyalkylamide crosslinkers are highly weather-stable, very flexible, hard, and chemically resistant. The carboxyl-containing polyesters are prepared from aliphatic and/or cycloaliphatic polyols with aliphatic and/or cycloaliphatic polycarboxylic acids and anhydrides.

EP 0 649 890 describes coating systems comprising β-hydroxyalkylamides and carboxyl-functional polyesters which are prepared from aliphatic diols, polyols, and dicarboxylic acids, at least 80% of the dicarboxylic acid component contain isophthalic acid.

Powder coating materials having improved physical aging stability are described by EP 0 664 325. These powder coating materials are based on linear carboxyl-functional polyesters and polyfunctional epoxides and/or β-hydroxyalkylamides. The acidic polyester contains not more than 10 mol % of isophthalic acid based on the sum of all carboxylic acids used.

All of the powder coating materials mentioned above based on a β-hydroxyalkylamide crosslinker include carboxyl-functional polyesters prepared by polycondensation of a polyol with a dicarboxylic acid or with a dicarboxylic acid and an anhydride.

### SUMMARY OF THE INVENTION

Accordingly, it is an object of the present invention to provide powder coating materials which comprise acidic polyesters that are less expensive than those of the prior art, and whose coatings, following crosslinking with a β-hydroxyalkylamide, provide a high profile of mechanical and outdoor resistance properties.

Surprisingly it has been found that coatings comprising β-hydroxyalkylamide crosslinkers and carboxyl-functional polyesters prepared by polycondensation of alcohols with carboxylic acids and carboxylic esters are more favorably priced and in fact have improved technological properties.

The invention provides a transparent or pigmented powder coating material that comprises at least one carboxyl-containing polyester and at least one β-hydroxyalkylamide. The polyester may be prepared by condensation of

A) at least one aliphatic and/or cycloaliphatic diol and/or polyol with

B) at least one aliphatic and/or cycloaliphatic and/or aromatic dicarboxylic and/or polycarboxylic acid and

C) at least one aliphatic and/or cycloaliphatic and/or aromatic dicarboxylic and/or polycarboxylic ester.

The resulting polyester has a glass transition temperature of from 30 to 90° C. and an acid number of from 10 to 150 mg KOH/g.

The coating material may consist of only the carboxyl-containing polyester and the β-hydroxyalkylamide or the coating material may further comprise one or more additional components.

### DESCRIPTION OF THE PREFERRED EMBODIMENTS

The present invention provides for the use of a carboxyl-containing polyester with β-hydroxyalkylamides for preparing transparent or pigmented powder coating materials where the polyester is prepared by condensation of

A) at least one aliphatic and/or cycloaliphatic diol and/or polyol with

B) at least one aliphatic and/or cycloaliphatic and/or aromatic dicarboxylic and/or polycarboxylic acid and

C) at least one aliphatic and/or cycloaliphatic and/or aromatic dicarboxylic and/or polycarboxylic ester;

to provide a polyester having a glass transition temperature of from 30 to 90° C. and an acid number of preferably from 10 to 150 mg KOH/g. In another embodiment of the invention the acid number may be less than 10 mg KOH/g.

The acidic polyesters (carboxyl-containing polyesters) may be obtained conventionally by condensation in an inert gas atmosphere at temperatures from 100 to 260° C., preferably from 130 to 220° C., in the melt or azeotropically, as described, for example, in Methoden der Organischem Chemie (Houben-Weyl), Vol. 14/2, 1-29, 40-47, Georg Thieme Verlag, Stuttgart, 1963 or in C. R. Martens, Alkyd Resins, 51-59, Reinhold Plastics Appl. Series, Reinhold Publishing Comp., New York, 1961 (that portion relevant to the condensation of alcohols with carboxylic acids and esters is incorporated herein by reference).

Essential to the invention is the use of a combination of at least one aliphatic and/or cycloaliphatic and/or aromatic dicarboxylic and/or polycarboxylic acid and one aliphatic and/or cycloaliphatic and/or aromatic dicarboxylic and/or polycarboxylic ester. It is unimportant which alcohol component is used to esterify the dicarboxylic or polycarboxylic acid. Preference is given to methyl esters.

Examples of carboxylic acids used for preparing polyesters include the following: succinic, adipic, suberic, azelaic, sebacic, phthalic, terephthalic, isophthalic, trimellitic, pyromellitic, tetrahydrophthalic, hexahydrophthalic, hexahydroterephthalic, dichlorophthalic, tetrachlorophthalic, endomethylenetetrahydrophthalic, glutaric, and 1,4-cyclohexanedicarboxylic acids and their esters. Especially suitable acids are isophthalic acid, terephthalic acid, hexahydroterephthalic acid, hexahydrophthalic acid, adipic acid, succinic acid, and their esters.

Examples of suitable polyols for preparing the polyesters include monoethylene glycol, 1,2- and 1,3-propylene glycol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), 1,4-bis(hydroxymethyl)cyclohexane, 2,2-bis(4-hydroxycyclohexyl)propane, 2,2-bis[4-(,-hydroxyethoxy)phenyl]propane, 2-methylpropane-1,3-diol, 2-methylpentane-1,5-diol, 2,2,4(2,4,4)-trimethylhexane-1,6-diol, glycerol, trimethylolpropane, trimethylolethane, hexane-1,2,6-triol, butane-1,2,4-triol, tris(β-hydroxyethyl) isocyanurate, pentaerythritol, mannitol, and sorbitol, and also diethylene glycol, triethylene glycol, tetraethylene glycol, dipropylene glycol, polypropylene glycols, polybutylene glycols, xylylene glycol, and neopentyl glycol hydroxypivalate.

Preferred alcohols are monoethylene glycol, butane-1,4-diol, pentane-1,5-diol, hexane-1,6-diol, neopentyl glycol, 1,4-bis(hydroxymethyl)cyclohexane, 2,2,4(2,4,4)-trimethylhexane-1,6-diol, neopentyl glycol hydroxypivalate, trimethylolpropane, and glycerol.

Amorphous polyesters prepared in this way have a glass transition temperature of from 30 to 90° C. and an acid number of from 10 to 150 mg/KOH/g.

The β-hydroxyalkylamides are known in principle and are described, for example, in EP 0 957 082, U.S. Pat. No. 4,076,917, U.S. Pat. No. 4,101,606, EP 0 322 834, WO 00/55 266, DE 100 04 136, EP 0 957 082, and EP 1 203 763.

Particularly preferred β-hydroxyalkylamides include VESTAGON EP-HA 320 from Degussa, PRIMID XL-552, PRIMID QM 1260, and PRIMID SF 4510 from EMS, and PROSID H and PROSID S from SIR Industriale. Materials such as N,N,N′,N′-Tetrakis(2-hydroxyethyl)adipamide, N,N,N′,N′-Tetrakis(2-hydroxypropyl)adipamide, N,N-Bis(2-hydroxyethyl)-4-tert-butylphenylamide are preferred.

The structure of these β-hydroxyalkylamides may be described as follows:

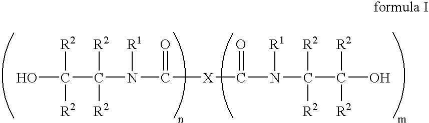

where the substituents are defined as follows:

X denotes a chemical bond, hydrogen or a monovalent or polyvalent organic group derived from saturated, unsaturated or aromatic hydrocarbon groups, having 1-24 carbon atoms, or these radicals with heteratom substitution;

R¹ denotes hydrogen or an alkyl, alkenyl, aryl or aralkyl radical having 1-24 carbon atoms, these radicals with heteroatom substitution, or

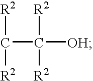

R² denotes, independently at each occurrence, identical or different radicals selected from hydrogen or an alkyl, aryl, aralkyl or alkenyl radical having 1-24 carbon atoms, or these radicals with heteroatom substitution;

n denotes an integer 1-10;

m denotes an integer 0-2; and

n+m is≧1.

Preferred compounds used to prepare the powder coating materials of the invention are prepared in accordance with EP 0 957 082 and are specified on page 4 of the A2 text (that portion of EP 0 957 082 relevant to the preparation of compounds used to make the invention coating materials is incorporated herein by reference).

Polyester compositions prepared from at least one polycarboxylic acid and at least one polycarboxylic ester and a β-hydroxyalkylamide are suitable binders for thermosetting coating materials, especially powder coating materials.

The mixing ratio of the carboxyl-containing polyester and the β-hydroxyalkylamide compound is generally chosen such that the ratio of carboxyl groups to hydroxyl groups is from 0.4:1 to 2.0:1. The mixing ratio may be any number between 0.4:1 and 2.0:1 including all ranges and subranges therebetween, including for example 0.5:1 to 1.9: 1, 0.4:1 to 1.8:1, 0.3 to 1.0:1 etc.

One or more additives may be present in the powder coating materials. The additives include, for example, leveling agents, devolatilizers, fillers, dyes, catalysts, light stabilizers, heat stabilizers, antioxidants and/or effect additives. They are normally present in amounts of from 0.5 to 50% by weight.

To prepare the ready-to-use powder coating materials the acidic polyester and β-hydroxyalkylamide, together, where appropriate, with pigments or fillers such as TiO₂ or barium sulfate and further customary powder coatings additives or auxiliaries such as leveling agents, such as polybutyl acrylate, for example, or devolatilizers such as benzoin, are mixed. All ingredients of the powder coating material are homogenized in the melt. This can be carried out in a suitable apparatus, such as a heatable kneading apparatus, but preferably by extrusion, during which an upper temperature limit of 140° C. is not preferably exceeded. After cooling to room temperature and comminution, the extruded mass is ground to give a ready-to-spray powder. The application of said powder to suitable substrates can take place in accordance with the known techniques, such as by electrostatic or tribostatic powder spraying or by fluid-bed sintering with or without electrostatic assistance, for example. Following powder application, the coated workpieces are cured by heating at a temperature from 140 to 220° C. for from 60 to 5 minutes.

The prior art powder coating materials based on acidic polyesters and β-hydroxyalkylamides have the drawback that the polyesters used are based on polycarboxylic acids and also their anhydrides. As a result, the preparation costs for the polyesters are higher in comparison with the powder coating materials of the invention which comprise carboxyl group-containing polyesters prepared from diols and/or polyols and a combination of carboxylic acids and carboxylic esters. The higher production costs undesirably raise the powder coating costs for the coater.

A technological drawback when using the polyesters of the invention in powder coating materials is not discernible at the present time. On the contrary, among other things, the coatings produced from these acidic (e.g., carboxyl-containing) polyesters possess technological advantages as well as advantages in terms of raw material costs.

When mixtures of carboxylic acid and carboxylic ester are used for preparing the carboxyl group-containing polyesters, the resulting polyesters possess few unwanted COOMe end groups since carboxylic esters have a higher rate of reaction with alcohols in comparison to carboxylic acids. As a result, few chain terminations are initiated during the preparation of the polyester. It is therefore possible to obtain a higher molar mass in the polyester, which in turn may enhance the flexibility of the coating.

Furthermore, polyesters can be synthesized in a more targeted fashion if different carboxylic acids and/or their esters are used. As an example, it is possible to produce a straight structure in the center of the chain (dimethyl terephthalate) and an angled arrangement of isophthalic acid units at the chain ends by using dimethyl terephthalate and isophthalic acid. A polyester with this construction adheres better in the coating material than a randomly synthesized polyester of terephthalic acid and isophthalic acid.

Moreover, the polyester chains prepared from condensation of mixtures of a 10 carboxylic acid and a carboxylic ester with one or more polyols have greater possibilities for addition. Greater π-π interaction make the coating more chemically resistant.

The subject matter of the invention is illustrated below with reference to examples which are not intended to further limit the claimed invention.

### EXAMPLES

1. Raw Materials Used

1.1 Acidic Polymer

A 3 1 three-necked flask equipped with a stirrer, a distillation column, and a nitrogen inlet was charged with 35 g of monoethylene glycol, 405 g of neopentyl glycol, 691 g of dimethyl terephthalate and 100 ppm of titanium tetraisopropoxide. After this charge had been heated to 170° C. with introduction of nitrogen, methanol began to boil and was distilled off. When the acid number had fallen to below three, 148 g of isophthalic acid were added. The mixture was heated at 200° C. for three hours. The resulting polyester had an acid number of 35 mg KOH/g, a hydroxyl number of <1 mg KOH/g, and a glass transition temperature of 57° C.

1.2 Acidic Polymer

A 3 1 three-necked flask equipped with a stirrer, a distillation column, and a nitrogen inlet was charged with 34 g of monoethylene glycol, 397 g of neopentyl glycol, 9 g of trimethylpropane, 672 g of dimethyl terephthalate and 100 ppm of titanium tetraisopropoxide. After this charge had been heated to 170° C. with introduction of nitrogen, methanol began to boil and was distilled off. When the acid number had fallen to below three, 167 g of terephthalic acid were added. The mixture was heated at 200° C. for three hours. The resulting polyester had an acid number of 38 mg KOH/g, a hydroxyl number of <1 mg KOH/g, and a glass transition temperature of 56° C.

1.3 β-Hydroxyalkylamide

The β-hydroxyalkylamide used was VESTAGON® EP-HA 320 (OH number 668 mg KOH/g, Degussa AG).

2. Powder Coatings

2.1 General Preparation Instructions

The comminuted product—that is, acidic polyester, β-hydroxyalkylamide compound, leveling agent, and devolatilizer—were intimately mixed with the white pigment in an edge runner mill and the mixture was then homogenized in a twin-screw extruder from Berstorff at a maximum temperature of 140° C. After cooling, the extrudate was fractionated and ground to a particle size <100 μm using a pinned-disk mill. The powder thus produced is applied using an electrostatic powder spraying unit at 60 kV to degreased and optionally pretreated iron panels which are baked in a forced air drying oven at temperatures of from 140 to 220° C.

The abbreviations in the tables below have the following meanings:

| | |
|---|---|
| FT = | film thickness in μm |
| EC = | Erichsen cupping (DIN 53 156) |
| CC = | cross-cut test (DIN 53 151) |
| GG 60° angle = | Gardner gloss measurement (ASTM-D 5233) |
| Imp. rev. = | impact reverse inch · lb |

2.2 Performance Testing

TABLE 1
Pigmented powder coatings

| Example | 1 | 2 |
|---|---|---|
| Formulation | | |
| Polyester from 1.1 | 605 g | — |
| Polyester from 1.2 | — | 603 g |
| VESTAGON ® EP-HA 320 | 32 g | 34 g |
| Auxiliaries/additives: | 350 g TiO₂ (white pigment), 1.0% | |
| | by weight Resiflow PV 88, 0.3% by | |
| | weight benzoin | |
| Coatings data | | |
| FT | 70-80 | 65-82 |
| CC | 0 | 0 |
| GG 60° angle | 93 | 92 |
| EC | >10 | >10 |
| Imp. Rev. | >160 | >160 |

| | |
|---|---|
| Curing: | 180° C./15 minutes |

German application no. 102 33 010.7, filed on Jul. 20, 2002, is incorporated by reference herein in its entirety.

Obviously, numerous modifications and variations of the present invention are possible in light of the above teachings. It is therefore to be understood that within the scope of the appended claims, the invention may be practiced otherwise than as specifically described herein.

1. A composition comprising at least one carboxyl-containing polyester and at least one β-hydroxyalkylamide, wherein the polyester comprises condensed units of
A) at least one of an aliphatic diol, cycloaliphatic diol or polyol,
B) at least one of an aliphatic carboxylic acid, cycloaliphatic carboxylic acid, aromatic dicarboxylic acid or polycarboxylic acid,
C) at least one of an aliphatic carboxylic ester, cycloaliphatic carboxylic ester, aromatic dicarboxylic ester or polycarboxylic ester.
wherein the polyester has a glass transition temperature of from 30 to 90° C. and an acid number of from 10 to 150 mg KOH/g.

2. The composition of claim 1, wherein A) is at least one selected from the group consisting of monoethylene glycol, 1,2-propylene glycol, 1,3-propylene glycol, 1,4-butylene glycol, 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), 1,4-bis(hydroxymethyl)-cyclohexane, 2,2-bis(4-hydroxycyclohexyl)propane, 2,2-bis[4-(β-hydroxyethoxy)phenyl]-propane, 2-methylpropane-1,3-diol, 2-methylpentane-1,5-diol, 2,2,4(2,4,4)-trimethylhexane-1,6-diol, glycerol, trimethylolpropane, trimethylolethane, hexane-1,2,6-triol, butane-1,2,4-triol, tris(β-hydroxyethyl) isocyanurate, pentaerythritol, mannitol, sorbitol, diethylene glycol, triethylene glycol, tetraethylene glycol, dipropylene glycol, a polypropylene glycol, a polybutylene glycol, xylylene glycol, and neopentyl glycol hydroxypivalate.

3. The composition of claim 1, wherein B) is at least one selected from the group consisting of succinic acid, adipic acid, suberic acid, azelaic acid, sebacic acid, phthalic acid, terephthalic acid, isophthalic acid, trimellitic acid, pyromellitic acid, tetrahydrophthalic acid, hexahydrophthalic acid, hexahydroterephthalic acid, dichlorophthalic acid, tetrachlorophthalic acid, endomethylenetetrahydrophthalic acid, glutaric acid, and 1,4-cyclohexanedicarboxylic acid.

4. The composition of claim 1, wherein B) is at least one selected from the group consisting of isophthalic acid, terephthalic acid, hexahydroterephthalic acid, hexahydrophthalic acid, adipic acid, and succinic acid.

5. The composition of claim 1, wherein B) is at least one selected from the group consisting of isophthalic acid and terephthalic acid.

6. The composition of claim 1, wherein C) is at least one selected from the group consisting of succinic ester, adipic ester, suberic ester, azelaic ester, sebacic ester, phthalic ester, terephthalic ester, isophthalic ester, trimellitic ester, pyromellitic ester, tetrahydrophthalic ester, hexahydrophthalic ester, hexahydroterephthalic ester, dichlorophthalic ester, tetrachlorophthalic ester, endomethylenetetrahydrophthalic ester, glutaric ester, and 1,4-cyclohexanedicarboxylic ester.

7. The composition of claim 1, wherein C) is at least one selected from the group consisting of isophthalic acid ester, terephthalic acid ester, hexahydroterephthalic acid ester, hexahydrophthalic acid ester, adipic ester, and succinic ester.

8. The composition of claim 1, wherein C) is at least one selected from the group consisting of isophthalic ester and terephthalic ester.

9. The composition of claim 1, wherein A) is at least one selected from the group consisting of an aliphatic diol, a cycloaliphatic diol, and a polyol; B) is at least one selected from the group consisting of an aliphatic acid, a cycloaliphatic acid, an aromatic dicarboxylic acid and a polycarboxylic acid; and C) is at least one selected from the group consisting of an aliphatic ester, a cycloaliphatic ester, an aromatic dicarboxylic ester and a polycarboxylic ester.

10. The composition of claim 1, wherein A) is at least one selected from the group consisting of an aliphatic diol, a cycloaliphatic diol and a polyol; B).is at least one selected from the group consisting of an aliphatic acid, an aromatic dicarboxylic acid and a polycarboxylic acid; and C) is at least one selected from the group consisting of an aliphatic ester, an aromatic dicarboxylic ester, and a polycarboxylic ester.

11. The composition of claim 1, wherein A) is at least one selected from the group consisting of an aliphatic diol, a cycloaliphatic diol and a polyol; B) is at least one selected from the group consisting of an aromatic dicarboxylic acid and a polycarboxylic acid; and C) is at least one selected from the group consisting of an aromatic dicarboxylic ester and a polycarboxylic ester.

12. The composition of claim 1, wherein the β-hydroxyalkylamide is selected from the group consisting of N,N,N′,N′-Tetrakis(2-hydroxyethyl)adipamide, N,N,N′,N′-Tetrakis(2-hydroxypropyl)adipamide, and N,N-Bis(2-hydroxyethyl)-4-tert-butylphenylamide.

13. The composition of claim 1, wherein the polyester is prepared by condensing the units at a temperature of from 100 to 260° C.

14. The composition of claim 1, wherein the polyester is prepared by condensing the units at a temperature of from 130 to 220° C.

15. The composition of claim 1, wherein the polyester is prepared by condensing the units in the melt or azeotropically.

16. The composition of claim 1, further comprising one or more additives selected from the group consisting of a leveling agent, a devolatilizer, a filler, a dye, a catalyst, a light stabilizer, a heat stabilizer, an antioxidant, and an effect additive.

17. The composition of claim 1, wherein the ratio of the polyester and the β-hydroxyalkylamide is from 0.4:1 to 2.0:1, based on the ratio of carboxyl groups of the polyester to hydroxyl groups of the hydroxyalkylamide.

18. The composition of claim 1, wherein the β-hydroxyalkylamide is of formula I 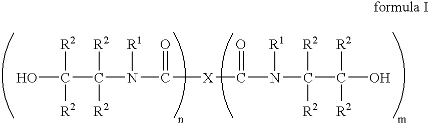
wherein
X is a chemical bond, hydrogen or a monovalent or polyvalent organic group derived from saturated, unsaturated or aromatic hydrocarbon groups, having 1-24 carbon atoms, that may be heteratom substituted;
R¹ is hydrogen or an alkyl, alkenyl, aryl or aralkyl radical having 1-24 carbon atoms, that may be heteroatom substituted, or 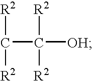
wherein
R² is, independently, one or more, identical or different radicals selected from hydrogen, an alkyl, aryl, aralkyl or alkenyl radical having 1-24 carbon atoms, that may be heteroatom substituted;
n is an integer 1-10;
m is an integer 0-2; and
n+mis ≧1.

19. In a powder coating composition, wherein the improvement comprises, the presence of a composition comprising at least one carboxyl-containing polyester and at least one β-hydroxyalkylamide, wherein the polyester comprises condensed units of
A) at least one of an aliphatic diol, cycloaliphatic diol or polyol,
B) at least one of an aliphatic carboxylic acid, cycloaliphatic carboxylic acid, aromatic dicarboxylic acid or polycarboxylic acid,
C) at least one of an aliphatic carboxylic ester; cycloaliphatic carboxylic ester, aromatic dicarboxylic ester or polycarboxylic ester.
wherein the polyester has a glass transition temperature of from 30 to 90° C. and an acid number of from 10 to 150 mg KOH/g.

20. A method for preparing the composition of claim 1, comprising mixing the polyester with the β-hydroxyalkylamide.

21. The method of claim 20, further comprising
mixing at least one of a filler or an additive with the polyester and the β-hydroxyalkylamide.

22. The method of claim 20, wherein the polyester and the β-hydroxyalkylamide are mixed by extrusion.

23. The method of claim 20, wherein the polyester and the β-hydroxyalkylamide are mixed at a temperature of ≧140° C.

24. A coating obtained by covering a substrate with the composition of claim 1, and cross-linking the composition.

25. A process comprising
applying a powder comprising the composition of claim 1, to a substrate to form a coated substrate, and
heating the coated substrate to a temperature of from 140 to 220° C.

26. The method of claim 25, wherein the powder composition is applied by electrostatic power spraying, tribostatic power spraying, or fluid-bed sintering.

27. A coated substrate obtained by the process as claimed in claim 25.
